(19) United States
(12) Patent Application Publication
(10) Pub. No.: US 2026/0370564 A1
(43) Pub. Date: Nov. 19, 2026

(54) METHOD AND APPARATUS OF SUPPORTING ARTIFICIAL INTELLIGENCE

(71) Applicant: LENOVO (BEIJING) LIMITED, Beijing (CN)

(72) Inventors: Jianfeng Wang, Beijing (CN); Bingchao Liu, Beijing (CN)

(21) Appl. No.: 19/138,753

(22) PCT Filed: Dec. 16, 2022
(86) PCT No.: PCT/CN2022/139752

§ 371 Date: Jun. 13, 2025

(51) Int. Cl. H04L 41/16

(52) U.S. Cl. CPC H04L 41/16

(57) ABSTRACT

Embodiments of the present application relate to a method and apparatus of supporting artificial intelligence (AI). An exemplary method includes: transmitting a request of at least one dataset, wherein the request indicates identification information of each dataset of the at least one dataset, and each dataset is associated with at least one corresponding AI model; and receiving a response to the request, wherein the response indicates the at least one dataset.

### TECHNICAL FIELD

Embodiments of the present application are related to wireless communication technology, especially, related to artificial intelligence (AI) application in wireless communication, e.g., a method and apparatus of supporting AI.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” (or “AI/ML model” or “model” etc.) to learn how to solve problems and/or optimize performance from vast amounts of data.

If AI models used on AI-based methods are well trained, the AI-based methods can obtain better performance than traditional methods. Thus, 3rd generation partnership program (3GPP) has been considering to introduce AI into 3GPP since 2016, including several study items and work items in SA1, SA2, SA5and radio access network (RAN) 3.

A typical AI approach mainly includes two phases, i.e., training (or model training) phase and inference phase. In the training phase, vast amounts of data, e.g., datasets (or data sets) are fed into an AI model, e.g., a deep neural network (DNN), to learn and perform certain tasks without being explicitly programmed. After validation and testing, the AI model will be used for tasks in the inference phase.

Considering that data (datasets or data sets etc.) used to train an AI model play a key role for the performance of the AI model, data collection issues have been under study in RAN level since 3GPP release (R) 17 study, e.g., in RAN3 working group. In 3GPP R18 study item (SI) in RAN1 working group, it is also necessary to study more detailed enhancement on air interface to support flexible data collection schemes. For example, the industry desires technical solutions of well managing data collection used for model training and management to enhance the air interface in R18 and beyond.

### SUMMARY

One objective of the embodiments of the present application is to provide a technical solution for wireless communication, especially for supporting AI in wireless communication, which provides enhancements on air interface to support flexible data collection schemes.

Some embodiments of the present application provide an apparatus of supporting AI, e.g., a user equipment (UE) or a radio access network (RAN) node, which includes: a processor; and a transceiver coupled to the at least one processor, wherein the transceiver is configured to: transmit, to another apparatus, a request of at least one dataset, wherein the request indicates identification information of each dataset of the at least one dataset, and each dataset is associated with at least one corresponding AI model; and receive, from the other apparatus, a response to the request, wherein the response indicates the at least one dataset.

Some embodiments of the present application provide a method of supporting AI, e.g., a method performed in a UE or a RAN node, which includes: transmitting a request of at least one dataset, wherein the request indicates identification information of each dataset of the at least one dataset, and each dataset is associated with at least one corresponding AI model; and receiving a response to the request, wherein the response indicates the at least one dataset.

In some embodiments of the present application, the apparatus of supporting AI is one of a UE and a RAN node, and the other apparatus is another one of the UE and RAN node.

In some embodiments of the present application, each dataset is associated with an AI model by including identification information of the dataset in description information of the AI model.

According to some embodiments of the present application, the identification information of each dataset is determined by at least one of: scenario information, configuration information or zone information.

In some embodiments of the present application, the identification information of each dataset of the at least one dataset is carried in a radio resource control (RRC) message.

In some embodiments of the present application, the at least one dataset is requested at least for model training, and the processor is configured to: for each received dataset, train the at least one corresponding AI model with the received dataset.

According to some embodiments of the present application, the model training includes: model initial training.

According to some embodiments of the present application, the at least one dataset is carried in a RRC message.

According to some embodiments of the present application, the processor is further configured to: for each received dataset, perform model management to manage the at least one corresponding AI model with the received dataset.

In some embodiments of the present application, the at least one dataset is requested for model management, and the processor is configured to: for each received dataset, manage the at least one corresponding AI model with the received dataset.

According to some embodiments of the present application, the model management includes at least one of: on-line tuning, re-training, model monitoring, model updating or model selection.

According to some embodiments of the present application, the model management is specific for each related functionality or is common for all related functionalities.

According to some embodiments of the present application, the request further indicates identification information of each corresponding AI model.

According to some embodiments of the present application, each corresponding AI model is deployed in the apparatus or is transferred from the other apparatus. In some scenarios, for a transferred AI model, identification information of a dataset associated with the transferred AI model is also transferred from the other apparatus. In some other scenarios, for a transferred AI model, the transferred AI model is carried in a RRC message.

According to some embodiments of the present application, the at least one dataset is carried in a RRC message or in a media access control (MAC) control element (CE).

Some embodiments of the present application provide another apparatus of supporting AI, e.g., a UE or a RAN node, which includes: a processor; and a transceiver coupled to the processor, wherein the transceiver is configured to: receive, from another apparatus, a request of at least one dataset, wherein the request indicates identification information of each dataset of the at least one dataset, and each dataset is associated with at least one corresponding AI model; and transmit, to the other apparatus, a response to the request, wherein the response indicates the at least one dataset.

Some embodiments of the present application provide another method of supporting AI, e.g., a method performed in a UE or a RAN node, which includes: receiving a request of at least one dataset, wherein the request indicates identification information of each dataset of the at least one dataset, and each dataset is associated with at least one corresponding AI model; and transmitting a response to the request, wherein the response indicates the at least one dataset.

In some embodiments of the present application, the apparatus of supporting AI is one of a UE and a RAN node, and the other apparatus is another one of the UE and RAN node.

In some embodiments of the present application, the at least one dataset is requested for at least one of model training or model management.

According to embodiments of the present application, in the case that the at least one dataset is requested for model management, the request further indicates identification information of each corresponding AI model.

According to embodiments of the present application, each corresponding AI model is deployed in the other apparatus or is transferred to the other apparatus. In some scenarios, for a transferred AI model, identification information of a dataset associated with the transferred AI model is also transferred to the other apparatus. In some scenarios, for a transferred AI model, the transferred AI model is carried in a RRC message.

In some embodiments of the present application, the processor is configured to: for each dataset, collect data from at least one of offline simulation or online measurement within different application scopes; and generate the dataset based on the collected data.

Given the above, embodiments of the present application propose a technical solution of supporting AI in wireless communication, which solves the technical problem on how to identify dataset for model training and management in AI enhanced air interface, so that flexible data collection schemes will be supported and the data collection used for model training and management will be well managed. Accordingly, embodiments of the present application will facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 is a schematic diagram illustrating exemplary training of AI models with datasets according to some embodiments of the present application.

FIG. 3 is a flow chart illustrating an exemplary procedure of a method of supporting AI according to some embodiments of the present application.

FIG. 4 illustrates a flow chart of an exemplary procedure of a method of supporting AI in Cases A according to some embodiments of the present application.

FIG. 5 illustrates a flow chart of an exemplary procedure of a method of supporting AI in Cases B according to some embodiments of the present application.

FIG. 6 illustrates a block diagram of an apparatus of supporting AI according to some embodiments of the present application.

FIG. 7 illustrates a block diagram of an apparatus of supporting AI according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long-term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

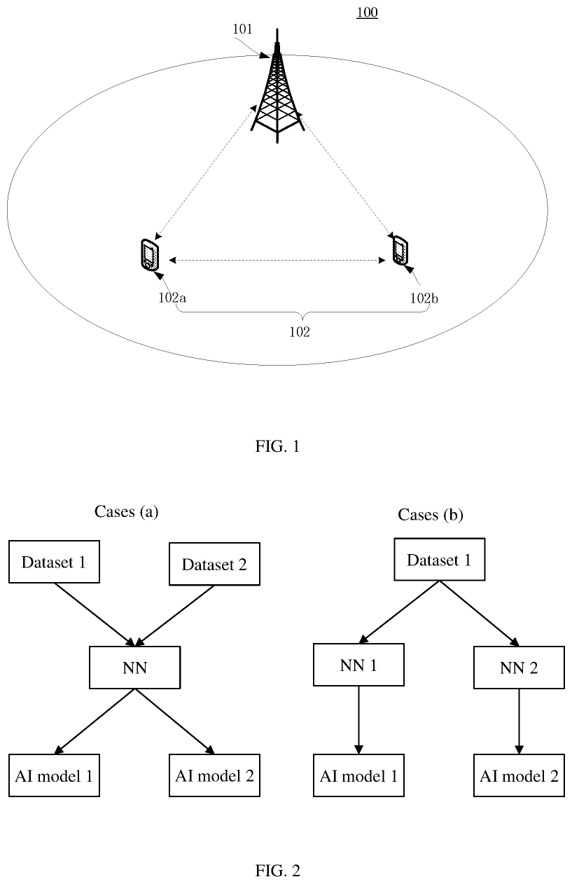

FIG. 1 illustrates a schematic diagram of an exemplary wireless communication system 100 according to some embodiments of the present application.

As shown in FIG. 1, the wireless communication system 100 includes at least one RAN node, e.g., base station (BS) 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

3GPP has been considering introducing AI capability (or application) for communication since 2016. For example, 3GPP is discussing to introduce AI into air interface and some relevant objectives of the SI in the study item description (SID) are reproduced below:
AI/ML model, terminology and description to identify common and specific characteristics for framework investigations:
   Dataset(s) for training, validation, testing, and inference
for the use cases under consideration:
   assess potential specification impact, specifically for the agreed use cases in the final representative set and for a common framework:
      physical (PHY) layer aspects, e.g., (RAN1):
         consider aspects related to, e.g., the potential specification of the AI Model lifecycle management, and dataset construction for training, validation and test for the selected use cases
         use case and collaboration level specific specification impact, such as new signalling, means for training and validation data assistance, assistance information, measurement, and feedback
      Protocol aspects, e.g., (RAN2)-RAN2 only starts the work after there is sufficient progress on the use case study in RAN1
         consider aspects related to, e.g., capability indication, configuration and control procedures (training/inference), and management of data and AI/ML model, per RAN1 input
         collaboration level specific specification impact per use case.

In general, a dataset needs to be constructed via online or offline data collection to train a deployed AI model, and the dataset (e.g., with assistance data) is needed to monitor a deployed model for better performance. In some degree, the performance of an AI model is decided by the dataset construction, that is, if the input data is much similar to the data in the training dataset, the monitoring or inference results will be more accurate to the expected ones.

According to RAN1 #110bis-e meeting, the data collection may be performed for different purposes in life-cycle management (LCM), including model training, model inference, model monitoring, model selection, model update, etc., each may be done with different requirements and have potential specification impact. That is, datasets can be used for model training and/or LCM (e.g., monitoring and updating etc.). Considering potential model generalization, a set of specific models, e.g., scenario/configuration-specific and site-specific models, need to be developed. Regarding LCM (or LCM procedure), it includes functionality-based LCM and model-ID-based LCM. That is, the LCM procedure is based on either functionality or model identity (ID) for the required operations, including activation, deactivation, switching and fallback etc.

In addition, the dataset may be constructed from the offline simulation and/or online measurement within different application scopes, e.g., deployment scenarios, system configurations, sites and zones. If a dataset is constructed within a specific scenario for an NN, the trained AI model will be expected to be applied in this specific scenario. Besides different datasets used for training different NNs, in some other cases, the same NN may be trained with different datasets, or different NNs may be trained with the same datasets. In any case, the obtained AI models associated with different NNs or different datasets are identified as different models, e.g., identified by different functionalities (functionality-based) or identified by other different identification manners (e.g., model ID).

FIG. 2 is a schematic diagram illustrating exemplary training of AI models with datasets according to some embodiments of the present application, wherein in cases (a), the same NN is trained with different datasets, while in cases (b), different NNs are trained with the same datasets.

Specifically, referring to FIG. 2, in cases (a), different datasets, e.g., data set 1 and dataset 2 are used to train the same NN. Accordingly, AI model 1 associated with (or tagged with) dataset 1 and AI model 2 associated with (or tagged with) dataset 2 will be obtained. In cases (b), the same dataset, e.g., dataset 1 is used to train different NNs, e.g., NN1 and NN2. Accordingly, AI model 1 associated with (or tagged with) dataset 1 will be obtained by training NN1, and AI model 2 associated with (or tagged with) dataset 1 will be obtained training NN2.

According to some embodiments of the present application, dataset identification information, e.g., dataset ID will be included in description information of an AI model to identify a dataset associated with the AI model, which will be available and managed within a model LCM entity. In some cases, the dataset identification information may also be used to indicate sharing the same dataset for different AI models with different functionalities, e.g., channel state information (CSI) compression and beam management etc. to avoid redundant transmission. Herein (throughout all the embodiments of the present application), the AI model may also be referred to as model, or AI/ML model etc.

The dataset identification information, e.g., dataset ID can be determined by (or designed with) at least one of: scenario information, configuration information, zone information or other application scope information, e.g., by single scenario information, configuration information or zone information (e.g., zone ID) or by any combination of them. Flexible use of such scope information can realize model generalization. For example, Table 1 shown below illustrates exemplary dataset identification information defined by a flexible combination of various application scope information.

TABLE 1

| | Scenarios | | | | Configurations | | | |
|---|---|---|---|---|---|---|---|---|
| Dateset | | | | UE | # of Tx | # of Tx | # of SRS | # of Rx |
| ID | Propagation | ISD | O/I | speed | ports | beams | ports | beams |
| 1 | UMi | 200 m | 20/80 | 3 km/h | 32 | 8 | 4 | 1 |
| 2 | UMi | 200 m | 20/80 | 3 km/h | 64 | 16 | 8 | 4 |
| 3 | UMa | 500 m | 100/0 | 30 km/h | 64 | 32 | 8 | 4 |
| . . . | . . . | . . . | . . . | | | | | |

It can be seen, different datasets are identified by different combinations of scenario information and configuration information. For example, dataset ID 1 is determined by scenario information including propagation being Urban Micro (UMi), inter site distance (ISD) being 200 m, the ratio of outdoor and indoor users (O/I) being 20/80 and UE speed being 3 km/h and configuration information including the number of transmitting (Tx) ports being 32, the number of Tx beams being 8, the number of sounding reference signal (SRS) port being 4 and the number of receiving (Rx) beams being 1.

According to the agreed AI/ML-based approaches, there are two kinds of AI models: single-side, i.e., either in remote side (e.g., UE side) or network side (e.g., gNB side); and two-side, i.e., in both remote side and network side. In any approach, it may be possible to transfer the AI model over the air interface (e.g., network and UE collaboration Level z). On the other hand, in the case that the AI model on one side (e.g., the remote side) needs to be trained and/or managed, the dataset (or assistant data) associated with the AI model may need to be transferred from the other side (e.g., the network side), which needs to be identified via the dataset identification information. That is, the dataset identification information may also need to be transferred over the air interface.

— AI-DataSetId
The IE AI-DataSetId identifies a dataset for AI models. The AI-DataSetId of an AI-DataSet is the index
of an AI-DataSet. The first element in that list is referred to by AI-DataSetId = 1. The AI-DataSetId=0 is
not used by an actual AI-DataSet but means that
AI-DataSetId information element
-- ASN1START
-- TAG-AI-DATASETID-START

| | |
|---|---|
| AI-DataSetId ::= | INTEGER (0 .. maxNrofAIDataSets−1) |

-- TAG-AI-DATASETID-STOP
-- ASN1STOP
— AI-DataSet
The IE AI-DataSet indicates a set of data that the AI models used for training and other management
operations.
AI-DataSet information element
-- ASN1START
-- TAG-AI-DATASET-START

| AI-DATASET ::= | SEQUENCE { | |
|---|---|---|
| ai-DataSetId | AI-DataSetId, | |
| ai-Dataset-Scenario | SEQUENCE { | |
| Propagation | AssumingParameters | OPTIONAL, |
| ISD | AssumingParameters | OPTIONAL, |
| UEspeed | AssumingParameters | OPTIONAL |

} OPTIONAL,

| ai-Dataset-Configuration | SEQUENCE { | |
|---|---|---|
| NrofTxPorts | AssumingParameters | OPTIONAL, |
| NrofTxBeam | AssumingParameters | OPTIONAL, |
| NrofSRSPortss | AssumingParameters | OPTIONAL, |
| NrofRxBeam | AssumingParameters | OPTIONAL, |

```
  } OPTIONAL,
  ...
-- TAG-AI-DATASET-STOP
-- ASN1STOP
```

When the dataset identification information being transferred via air interface, a signaling or message carrying the dataset identification information may be a RRC signaling in some embodiments of the present application. One or more new information elements (IEs) may be introduced for the RRC signaling in the specification related to air interface. Exemplary IEs, e.g., “AI-DataSetld” and

“AI-DataSet” are illustrated above. Persons skilled in the art should well know that the exemplary IEs can be defined in other manners, e.g., the exemplary IE “AI-DataSet” can be extended to include more descriptions on the scenarios, configurations and/or other scope information on the dataset or collected data.

On the other hand, after being trained (e.g., after initial training), when an AI model is under use, e.g., in inference phase, the AI model will be managed, including on-line tuning, re-training, model monitoring, model updating or model selection etc. (in some cases, the AI model management may also be referred to as AI model monitoring, which also includes other management operations as illustrated above). The model management is specific for each related (or potential) functionality or is common for all related functionalities. For example, the performance of the AI model will be monitored, e.g., with the corresponding dataset, which may include assistant data, e.g., ground-truth data etc. Similarly, the corresponding dataset used for AI model management will also be indicated via the dataset identification information. In some cases, only the assistant data (or updated data or additional data) of the dataset will be transferred to reduce latency and overhead, while the dataset identification information is still needed.

```
—  AI-ModelMonitor
The IE AI-ModelMonitor indicates a set of data that the AI models used for monitoring operations.
                            AI-ModelMonitor information element
-- ASN1START
-- TAG-AI-MODELMONITOR-START
AI-MODELMONITOR ::=  SEQUENCE {
...
  ai-ModelId  AI-Model-Id,
  ai-DataSetId  AI-DataSetId,
...
-- TAG-AI-MODELMONITOR-STOP
-- ASN1STOP
```

Considering that, besides the above illustrated IEs, other new IEs may also be introduced for the RRC signaling in the specification related to air interface to indicate the dataset identification information. For example, the dataset ID for model monitoring or other management operations may be included in the RRC signaling which may be specific for each related functionality or is common for all related functionalities. An exemplary IE “AI-ModelMonitor” or the like, e.g., “AI-ModelManagement” is illustrated as above.

Persons skilled in the art should well know that the exemplary IE can be defined in other manners. For example, there will be more information in AI-ModelMonitor besides the AI model ID and the dataset ID, such as the performance matrix metric and the threshold for evaluation etc.

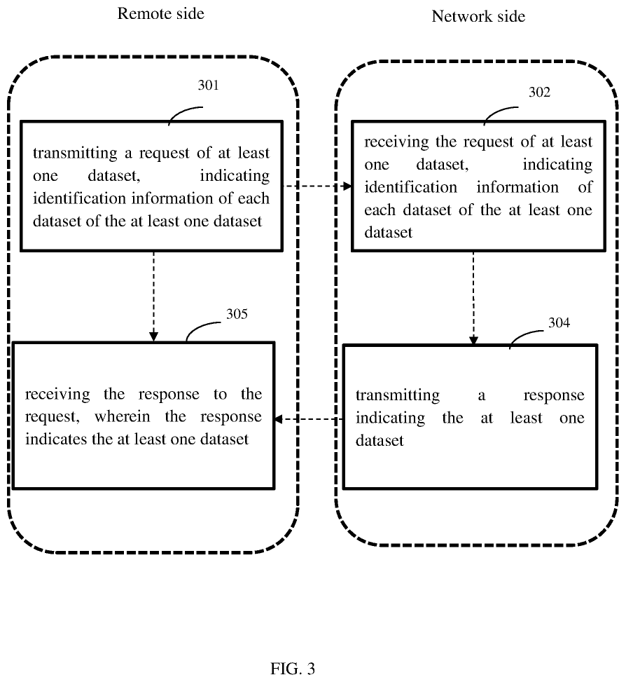

FIG. 3 illustrates a flow chart of an exemplary procedure of a method of supporting AI according to some embodiments of the present application, wherein the data identification information will be transferred in air interface. The exemplary procedure may be associated with AI model training, or AI model management, or both the AI model training and management.

Although the method is illustrated in a system level by two apparatus of supporting AI, e.g., a first apparatus and a second apparatus for clearness, persons skilled in the art can understand that the method implemented in each apparatus can be separately implemented and incorporated by other apparatus with similar functions. In addition, no transmission or reception failure is considered in the illustrated embodiments of the present application.

In addition, since the dataset and its data identification information may be transferred from one side of the remote side and network side to the other side, the first apparatus may be an apparatus in one of the remote side and network side, and the second apparatus may be an apparatus in the other side. For example, the first apparatus may be a UE while the second apparatus may be a gNB or another RAN node. In another example, the first apparatus may be a gNB or another RAN node while the second apparatus may be a UE.

Referring to FIG. 3, in step 301, the first apparatus may transmit a request of at least one dataset. Each dataset is associated with at least one corresponding AI model. That is, a requested dataset may be associated with one AI model or associated with multiple AI models. Each corresponding AI model is deployed in the first apparatus (that is, implemented, generated or constructed by the first apparatus itself) or is transferred from another apparatus, e.g., the second apparatus. For each corresponding AI model, the dataset may be used for training (e.g., initial training) (in training phase), or for management (e.g., monitoring or updating etc.) (in interference phase). The request indicates identification information of each requested dataset, which is provided as illustrated above, e.g., jointly determined by scenario information, configuration information and/or zone information etc.

In some embodiments of the present application, the request may be transmitted by a RRC signaling, wherein the identification information of each requested dataset will be indicated in an IE of the RRC signaling. For example, in the case that the requested dataset is for training or for training and management operations, IEs “AI-DataSetld” and “AI-DataSet” or the like may be included in the RRC signaling. In the case that the requested dataset is for monitoring operations or other management operations, IE “AI-ModelMonitor” or the like may be included in the RRC signaling.

The second apparatus will receive the request in step 302, and will transmit a response indicating the requested dataset to the first apparatus in step 304. Accordingly, the first apparatus will receive the requested dataset in step 305. The first apparatus will use the received dataset for training, or for management, or for both training and management of the corresponding IA model(s).

For example, the second apparatus may indicate the requested dataset to the first apparatus via a RRC signaling, e.g., via IEs “AI-DataSetld” and “AI-DataSet” or the like; or indicate the requested dataset (e.g., assistant data part) to the first apparatus via a MAC CE, e.g., a new defined MAC CE. In the case that the requested dataset is maintaining in the second apparatus and is ready to be transferred, the second apparatus may directly transmit the requested dataset to the first apparatus. In the case that the requested dataset has not been generated yet or needed to be updated, the second apparatus will collect data from at least one of offline simulation or online measurement within different application scopes; and generate (or construct) the dataset based on the collected data. Then, the second apparatus will transfer the requested dataset to the first apparatus.

In the case that the AI model is a transferred AI model, the first apparatus will first receive the AI model, e.g., from the second apparatus, which may be based on the request of the first apparatus or on the second apparatus's control. For example, the second apparatus will transfer the AI model to the first apparatus via a RRC signaling. Identification information of a dataset associated with the transferred AI model will also be transferred from the second apparatus, e.g., via an IE for model transfer in a RRC signaling.

For example, a new IE “AI-ModelTransfer” may be introduced for the RRC signaling in the specification related to air interface, which is illustrated below.

```
—  AI-ModelTransfer
The IE AI-ModelTransfer indicates a set of data that the AI models used for monitoring operations.
                            AI-ModelTransfer information element
-- ASN1START
-- TAG-AI-MODELTRANSFER-START
AI-MODELTRANSFER ::=  SEQUENCE {
...
  ai-ModelId AI-ModelID
  ai-DataSetId  AI-DataSetId,
...
-- TAG-AI-MODELTRANSFER-STOP
-- ASN1STOP
```

Persons skilled in the art should well know that the exemplary IE can be defined in other manners. For example, there will be more information in “AI-ModelTransfer” besides the dataset ID.

More detained embodiments of the present application will be illustrated in the following in view of the AI model(s) being deployed in the first apparatus or is transferred from another apparatus, e.g., the second apparatus. Hereafter, taking the

UE part models (or UE-side models) as an example, they are deployed in the UE side or transferred from the network side, e.g., from a gNB, that is, the first apparatus is UE and the second apparatus is gNB. Persons skilled in the art should clearly know how to apply the disclosed technical solutions to the network part models (or network-side models) under the disclosure and teaching in view of the UE part models (or UE-side models). In addition, the illustrated IEs and signaling are only used as an example, which should not be used to unduly limit the scope of the present application.

### Cases A: UE-Part/UE-Sided Models Deployed in the UE Side

According to some embodiments of the present application, the AI models are deployed at UE side, which need to be trained and/or managed with the data collected from the network.

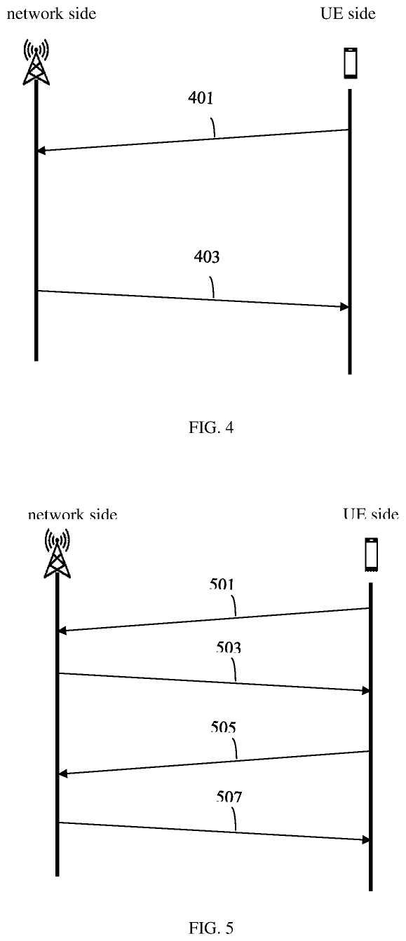

FIG. 4 illustrates a flow chart of an exemplary procedure of a method of supporting AI in Cases A according to some embodiments of the present application.

As shown in FIG. 4, one or more AI models, e.g., AI models #1, #2, #3 and #4 are deployed in the UE side.

To train and/or manage (e.g., monitor) these models, the UE may need to collect data (e.g., detailed data) from the network, e.g., gNB, which can be realized by sending a request of the datasets (e.g., a dataset transfer request) associated with these AI models in step 401. The datasets to be collected can be indicated by the dataset identification information, e.g., dataset ID, which are registered in the network side as model description information. Different AI models may need the same or different datasets, e.g., AI models #1 and #2 may share the same dataset. For example, respectively corresponding to AI models #1-#4 to be trained and/or managed, three datasets, e.g., datasets respectively with IDs 1, 2 and 3 are requested, wherein, AI models #1 and #2 share the same dataset, e.g., dataset 1, AI model #2 needs dataset 2 and AI model #4 needs dataset 3.

The dataset identification information, e.g., dataset ID={1, 2, 3} will be included for the corresponding AI models, which can be realized via the IE in a RRC signaling for the dataset transfer request, e.g., “AI-DataSetId” as illustrated above or by any other manners.

After receiving the dataset transfer request with the dataset identification information, the network side, e.g., gNB will collect the data to construct the requested datasets, correspondently. After constructing the requested dataset, the gNB will transfer the requested datasets with the corresponding dataset identification information to the UE in step 403, which can also be realized via a RRC signaling, e.g., via the IEs “AI-DataSetld” and “AI-DataSet” as illustrated above. In some cases, the requested dataset may have been maintained with collected data, and the gNB will directly send the requested dataset to the UE.

After receiving the datasets, the UE will perform training and/or management on the corresponding AI models with the requested datasets. For example, the UE will use dataset 1 to train and/or manage AI model #1 and #2, use dataset 2 to train and/or manage AI model #3, and use dataset 3 to train and/or manage AI model #4, respectively. Persons skilled in the art should well know that data of a dataset for an AI mode may be frequently updated to enhance the performance of the AI model. Thus, the same dataset does not mean the dataset will not change. Herein, any data collected for a dataset with the same identification information may refer to the dataset or a part of the dataset. For example, the dataset received from the network side may be updated with the data collected in the UE side. Thus, using the received dataset to manage the corresponding AI models should not be unduly limited to the dataset exactly the same as the dataset received from the network side.

### Case B: UE-Part/UE-Sided Models Transferred From Network Side

According to some embodiments of the present application, the AI models are deployed at network side, which will be transferred to the UE and will be managed with the data collected from the network.

FIG. 5 illustrates a flow chart of an exemplary procedure of a method of supporting AI in Cases B according to some embodiments of the present application.

As shown in FIG. 5, one or more AI models, e.g., AI models #1, #2, #3 and #4 are deployed in the network side. For the models available in the network, the corresponding datasets for them are also available. Different AI models may be associated with or trained by the same or different datasets. For example, AI models #1 and #2 share the same dataset, e.g., dataset 1, AI model #2 is associated with dataset 2 and AI model #4 is associated with dataset 3.

In some embodiments of the present application, the AI models may be transferred to the UE side on the network's own initiative or in response to UE's request. For example, the UE may request one or more AI models (model transfer request), e.g., AI models #1, #2, #3 and #4 deployed in the network side in step 501.

After receiving the model transfer request, the network will prepare the requested AI models and transfer them to the UE in step 503, e.g., via IE “AI-ModelTransfer” as illustrated above, which also includes the identification information of dataset(s) associated with these AI models. For example, when transferring the AI models, the dataset ID associated with each AI model is transferred together with the models in a manner as {Model ID, Dataset ID}={{1,1}, {2,1}, {3,2}, {4,3}} in “AI-ModelTransfer.”

After receiving these models, the UE may use them for management (or for use in interference phase), which may need the data (e.g., assistant data) from the network in some scenarios. For example, during the inference, the UE may need the assistant data from the network to perform monitoring operation. Accordingly, in step 505, the UE may transmit a request of datasets (e.g., dataset transfer request) associated the AI models. The dataset identification information is also included in the dataset transfer request. For example, the dataset identification information, e.g., dataset ID={1, 2, 3} will be included in the data transfer request for the corresponding AI models. The dataset transfer request may be similar to the data transfer request as illustrated in Cases A, e.g., via “AI-DataSetld” or the like, or be another IE supporting model monitoring, e.g., “AI-ModelMonitor” as illustrated above.

After receiving the dataset transfer request with the dataset identification information, the network side, e.g., gNB will collect the data (e.g., assistant data) to construct (or update or generate) the requested datasets, correspondently. The gNB will transfer the requested datasets with the corresponding dataset identification information to the UE in step 507, e.g., via the IEs “AI-DataSetId” and “AI-DataSet” similar to step 503; or via MAC CE wherein the dataset only providing the assistant data to satisfy the requirements on low latency. In some cases, the requested dataset may have been maintained with collected data, and the gNB will directly send the requested dataset to the UE.

Similarly, after receiving the datasets (e.g., with assistant data), the UE will perform management on the corresponding AI models with the requested datasets. For example, the UE will use dataset 1 to manage AI model #1 and #2, use dataset 2 to manage AI model #3, and use dataset 3 to manage AI model #4, respectively.

Besides the methods, embodiments of the present application also propose an apparatus of supporting AI.

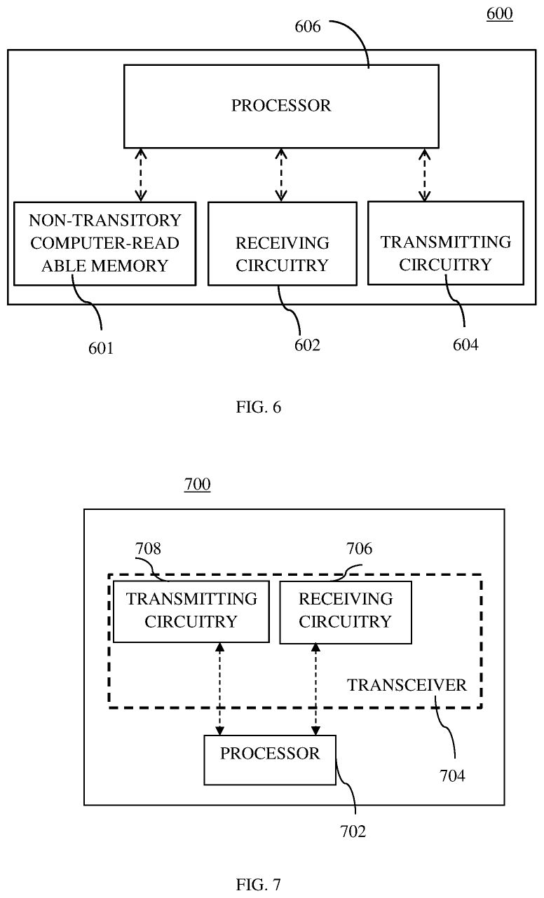

For example, FIG. 6 illustrates a block diagram of an apparatus of supporting AI 600 according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a central processing unit (CPU), a digital signaling processing (DSP), a microprocessor etc. The apparatus 600 may be a RAN node, e.g., a gNB or a remote apparatus, e.g., a UE configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to the RAN node, e.g., the gNB as described above. For example, the computer-executable instructions, when executed, cause the processor 606 interacting with receiving circuitry 602 and transmitting circuitry 604, so as to perform the steps with respect to the RAN node as depicted above.

In some embodiments of the present application, the non-transitory computer-readable medium 601 may have stored thereon computer-executable instructions to cause a processor to implement the method with respect to the remote apparatus, e.g., the UE as described above. For example, the computer-executable instructions, when executed, cause the processor 606 interacting with receiving circuitry 602 and transmitting circuitry 604, so as to perform the steps with respect to the remote apparatus as illustrated above.

FIG. 7 is a block diagram of an apparatus of supporting AI 700 according to some other embodiments of the present application.

Referring to FIG. 7, the apparatus 700, for example a RAN node or a UE may include at least one processor 702 and at least one transceiver 704 coupled to the at least one processor 702. The transceiver 704 may include at least one separate receiving circuitry 706 and transmitting circuitry 704, or at least one integrated receiving circuitry 706 and transmitting circuitry 704. The at least one processor 702 may be a CPU, a DSP, a microprocessor etc.

According to some embodiments of the present application, the apparatus 700 is one of a RAN node and a UE, which includes: a processor; and a transceiver coupled to the at least one processor, wherein the transceiver is configured to: transmit, to another apparatus, a request of at least one dataset, wherein the request indicates identification information of each dataset of the at least one dataset, and each dataset is associated with at least one corresponding AI model; and receive, from the other apparatus, a response to the request, wherein the response indicates the at least one dataset.

According to some embodiments of the present application, the apparatus 700 is the other one of a RAN node or a UE, which includes: a processor; and a transceiver coupled to the processor, wherein the transceiver is configured to: receive, from another apparatus, a request of at least one dataset, wherein the request indicates identification information of each dataset of the at least one dataset, and each dataset is associated with at least one corresponding AI model; and transmit, to the other apparatus, a response to the request, wherein the response indicates the at least one dataset.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. An apparatus that supports artificial intelligence (AI), the apparatus comprising:
at least one memory; and
at least one processor coupled with the at least one memory and configured to cause the apparatus to:
transmit, to another an other apparatus, a request of at least one dataset, wherein the request indicates identification information of each dataset of the at least one dataset, and each dataset is associated with at least one corresponding AI model; and
receive, from the other apparatus, a response to the request, wherein the response indicates the at least one dataset.

2. The apparatus of claim 1, wherein the apparatus is one of a user equipment (UE) and a radio access network (RAN) node, and the other apparatus is another one of the UE and the RAN node.

3. The apparatus of claim 1, wherein each dataset is associated with an AI model by including identification information of the dataset in description information of the AI model.

4. The apparatus of claim 3, wherein the identification information of each dataset is determined by at least one of: scenario information, configuration information, or zone information.

5. The apparatus of claim 1, wherein the identification information of each dataset of the at least one dataset is carried in a radio resource control (RRC) message.

6. The apparatus of claim 1, wherein at least one dataset is requested at least for model training, and the at least one processor is configured to cause the apparatus to:
for each received dataset, train the at least one corresponding AI model with the received dataset.

7. The apparatus of claim 1, wherein the at least one dataset is requested for model management, and the at least one processor is configured to cause the apparatus to:
for each received dataset, manage the at least one corresponding AI model with the received dataset.

8. The apparatus of claim 7, wherein the request further indicates identification information of each corresponding AI model.

9. The apparatus of claim 6, wherein the at least one dataset is carried in a radio resource control (RRC) message.

10. The apparatus of claim 7, wherein the at least one dataset is carried in a radio resource control (RRC) message or in a media access control (MAC) control element (CE).

11. An apparatus that supports artificial intelligence (AI), the apparatus comprising:
at least one memory; and
at least one processor coupled with the at least one memory and configured to cause the apparatus to:
receive, from an other apparatus, a request of at least one dataset, wherein the request indicates identification information of each dataset of the at least one dataset, and each dataset is associated with at least one corresponding AI model; and
transmit, to the other apparatus, a response to the request, wherein the response indicates the at least one dataset.

12. The apparatus of claim 11, wherein the at least one dataset is requested for at least one of model training or model management.

13. The apparatus of claim 12, wherein, in response to the at least one dataset being requested for model management, the request further indicates identification information of each corresponding AI model.

14. The apparatus of claim 11, wherein the at least one processor is configured to cause the apparatus to, for each dataset:
collect data from at least one of offline simulation or online measurement within different application scopes; and
generate the dataset based on the collected data.

15. A method for supporting artificial intelligence (AI) performed by an apparatus, the method comprising:
transmitting, to an other apparatus, a request of at least one dataset, wherein the request indicates identification information of each dataset of the at least one dataset, and each dataset is associated with at least one corresponding AI model; and
receiving, from the other apparatus, a response to the request, wherein the response indicates the at least one dataset.

16. The method of claim 15, wherein the apparatus is one of a user equipment (UE) and a radio access network (RAN) node, and the other apparatus is another one of the UE and the RAN node.

17. The method of claim 15, wherein each dataset is associated with an AI model by including identification information of the dataset in description information of the AI model.

18. The method of claim 17, wherein the identification information of each dataset is determined by at least one of: scenario information, configuration information, or zone information.

19. The method of claim 15, wherein the identification information of each dataset of the at least one dataset is carried in a radio resource control (RRC) message.

20. A method for supporting artificial intelligence (AI) performed by an apparatus, the method comprising:
receiving, from an other apparatus, a request of at least one dataset, wherein the request indicates identification information of each dataset of the at least one dataset, and each dataset is associated with at least one corresponding AI model; and
transmitting, to the other apparatus, a response to the request, wherein the response indicates the at least one dataset.
